(19) United States
(12) Patent Application Publication
(10) Pub. No.: US 2023/0128916 A1
(43) Pub. Date: Apr. 27, 2023

(54) ERROR DETECTION AT LAYERS OF A NEURAL NETWORK

(71) Applicant: ADVANCED MICRO DEVICES, INC., Santa Clara, CA (US)

(72) Inventors: Sriseshan Srikanth, Austin, TX (US); SeyedMohammad SeyedzadehDelcheh, Bellevue, WA (US)

(21) Appl. No.: 17/511,777

(22) Filed: Oct. 27, 2021

(51) Int. Cl. G06F 11/07; G06K 9/62; G06N 3/04

(52) U.S. Cl. CPC G06F 11/076; G06K 9/6257; G06N 3/04

(57) ABSTRACT

A processing system performs error detection at each of a plurality of layers of a neural network, such as a neural network implemented at a computational analog memory. By performing error detection at the layer level, the processing system is able to account for write errors when updating neural network weights, without waiting for backpropagation based on an output of the neural network. The processing system thereby reduces the amount of time needed to train the network, both by reducing the number of training epochs, and by reducing the length of the individual training epochs.

### BACKGROUND

Neural networks are used in a wide variety of applications, such as machine learning, image recognition, artificial intelligence, computer gaming, and others. A neural network is typically composed of a set of layers, with each layer including a set of artificial neurons, also referred to as nodes. Each node receives one or more input operands, either from an external input source or from another node, and performs a mathematical calculation using the input operands and a weight associated with the corresponding connection to the node, thereby generating an output operand that is provided to another node, or as an output of the neural network. In some cases, based on the output generated by the neural network, one or more of the weights is adjusted, thereby adapting the network to better handle an assigned task.

As the size and complexity of a neural network increases, the number of calculations required to implement the neural network also increases. Thus, for larger neural networks, the corresponding calculations demand a relatively large amount of processing system resources, such as power. Efficiency of a neural network can be increased, and the amount of system resources consumed by the neural network reduced, by implementing the neural network at a computational memory, such as a memory compute device that employs analog memory. However, such computational memories sometimes suffer from write reliability issues due to device variation, noise, and poor memory resolution. These issues can cause significant accuracy issues for the neural network, and thereby reduce overall neural network effectiveness.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system implementing a neural network with per-layer error detection in accordance with some embodiments.

FIG. 2 is a block diagram illustrating a layer of the neural network of FIG. 1, including a primary data path and a data residue path for error detection in accordance with some embodiments.

FIG. 3 is a block diagram illustrating an example of error detection at a layer of the neural network of FIG. 1 in accordance with some embodiments.

FIG. 4 is a flow diagram of a method of detecting errors at layers of a neural network in accordance with some embodiments.

FIG. 5 is a flow diagram of a method of retraining layers of a neural network based on detecting errors at the neural network layers in accordance with some embodiments.

### DETAILED DESCRIPTION

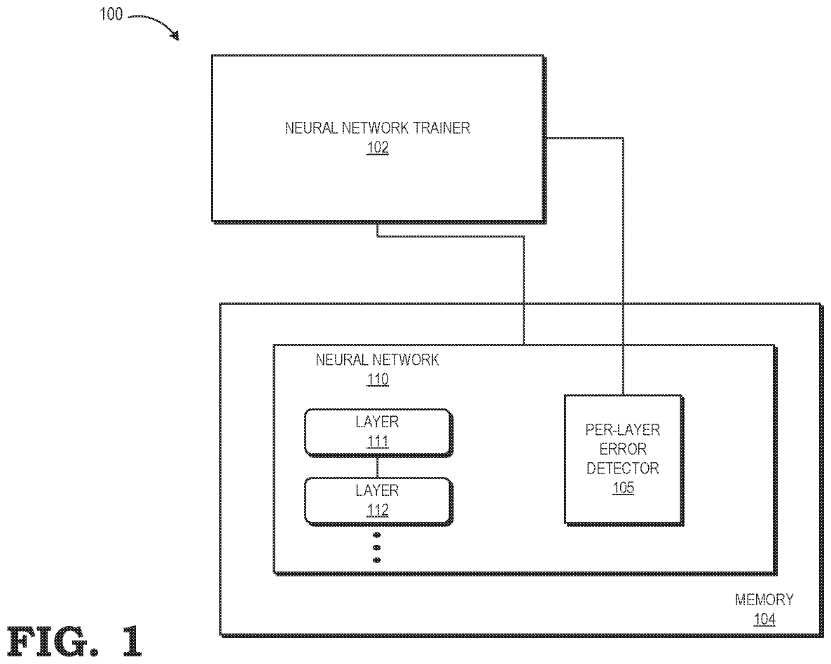

FIGS. 1-5 illustrate techniques for performing, at a processing system, error detection at each of a plurality of layers of a neural network, such as a neural network implemented at a computational analog memory. By performing error detection at the layer level, the processing system is able to account for write errors when updating neural network weights, without waiting for backpropagation based on an output of the neural network. The processing system thereby reduces the amount of time needed to train the network, both by reducing the number of training epochs, and by reducing the length of the individual training epochs.

To illustrate, in at least some cases the computational analog memory that implements the neural network will suffer from write-reliability issues, resulting in errors being generated at one or more layers of the neural network during network training. If left unaddressed during training, these errors are likely to significantly impact the accuracy and performance of the neural network. Conventionally, these errors are addressed by stochastically injecting errors to the training data during training, to mimic the reliability issues of the memory. The neural network is then trained with the injected errors until the neural network performs satisfactorily. However, this stochastic based approach has several shortcomings. For example, errors introduced in any part of the forward propagation phase of training are detected only upon a final training set correlation that prompts backpropagation throughout the neural network. This results in increased training time, and in particular lengthens the duration of each training epoch. Further, the stochastic nature of the error injection is likely to have limited correlation to the nature of errors imposed by analog memory. This results in a device-dependent increase in training time (and in particular, to the number of training epochs) with indeterminant convergence characteristics.

In contrast, using the techniques described herein, errors are detected at a layer granularity, allowing immediate retraining of the neural network when a threshold number of errors is detected at that layer. This in turn lowers the overhead for an individual training epoch, as the layer is retrained without waiting for backpropagation. Further, in some embodiments the error detection unit itself is trainable, thereby improving the accuracy of error detection at the individual layers, resulting in a lower number of training epochs.

In some embodiments, the error detection unit employs a residue-based error detection mechanism, wherein, during training of a layer, the node operands and corresponding residues for each node are read from an analog memory device for multiplication and addition operations corresponding to the node. The error detection unit then compares the corresponding output operands and residues and, in response to a mismatch, identifies an error at the node. As long as the total number of errors for a layer, across all the layer's nodes, is less than a trainable threshold, the training process continues at the next layer. Otherwise, the corresponding layer is retrained to prevent error propagation. By using this residue-based mechanism, errors are detected relatively efficiently, and without substantially increasing the size of the neural network itself. Furthermore, in some embodiments one or more parameters governing the residue-based mechanism, such as the size of the residue factor p or the thresholds for each layer that govern retraining, are themselves trainable by the neural network, further improving the accuracy and efficiency of the error detection.

FIG. 1 illustrates a processing system 100 that is generally configured to perform per-layer error detection at a neural network 110 in accordance with some embodiments. The neural network 110 is a network of nodes generally configured to be trained, using one or more machine learning training techniques and, once trained, perform one or more processing operations based on the training. Examples of such processing operations include, in different embodiments, image recognition, image compression, financial analysis, security operations, medical diagnostic operations, game engine operations, and the like. Accordingly, in different embodiments, the processing system 100 is any system that employs or implements neural-network-based operations, such as a desktop computer, laptop computer, server, tablet, smartphone, game console, and the like.

In the depicted embodiment, the neural network 110 includes a plurality of layers (e.g., layer 111, 112). Each layer includes a corresponding plurality of nodes, with each node including one or more inputs, either to receive data from another layer or to receive input data from an external source, and includes one or more outputs, either connected to corresponding inputs for other nodes or to provide output data for the neural network 110. Each input to a node is associated with a corresponding weight. Each node generates data at the corresponding output by performing a mathematical calculation (e.g., a multiplication, addition, or combination thereof) based on the input values and the weights associated with each input.

In the illustrated embodiment, the neural network 110 is implemented at a memory 104 of the processing system 100. In some embodiments, the memory 104 is an analog memory, including one or more analog storage cells (e.g., resistor-based storage cells) to store the values associated with each node of the neural network 110 and including circuits arranged between the cells to implement the mathematical operations for each node and each layer of the neural network 110. The memory 104 thus supports efficient implementation of the neural network 110, and allows for offloading of neural network operations from other processing elements of the processing system 100.

To train the neural network 110, the processing system 100 includes a neural network trainer (NNT) 102. The NNT 102 is a set of one or more circuits that collectively perform operations to train the neural network 110 to execute one or more specified tasks, such as image recognition, data analysis and the like. For example, in some embodiments, the NNT 102 is configured to provide a set of training data to an input layer of the neural network 110, and to activate the neural network 110 to generate a set of training output data. Each instance of the NNT 102 applying test data at the inputs of the neural network 110 and receiving corresponding training output data is referred to as a training epoch of the neural network 110.

For each training epoch, the NNT 102 compares the set of training output data to a set of expected results and, based on the comparison, provides control signaling to the neural network 110 to adjust one or more network parameters, such as one or more of the weights for one or more neural network nodes. The NNT 102 then reapplies the set of training data to the neural network 110 to initiate another training epoch with the adjusted network parameters. The NNT 102 continues to train the neural network, over additional training epochs, until the training output data matches the expected results, at least within a specified training tolerance.

As noted above, in some embodiments the neural network 110 is implemented at a memory employing analog memory cells. While such memory cells support efficient network operation, in at least some cases one or more of the memory cells suffers from write-reliability issues, resulting in errors being generated at one or more layers of the neural network 110 during network training. If left unaddressed during training, these errors will, at least in some cases, impact the accuracy and performance of the neural network 110. To address these errors, the neural network 110 includes a per-layer error detector 105 that is generally configured to detect errors at one or more individual layers of the neural network 110. Based on the detected errors, the NNT 102 initiates retraining at one or more of the individual layers. The processing system 100 is thus able to detect and remedy errors at the layer level during individual training epochs of the neural network 110, rather than waiting until the end of a training epoch to detect errors in the test output data, and addressing the errors at the network level.

To illustrate, in some embodiments the per-layer error detector 105 is a set of parallel nodes and corresponding parallel error data paths at the neural network 110. During training, the per-layer error detector 105 generates two error values at each node of a layer: an error value based on the primary data path of the node (i.e., the data path used by the neural network 110 during normal operation) and an error value based on the corresponding parallel node and error data path. The per-layer error detector 105 compares the two error values and, in response to the error values differing by more than a threshold value, identifies an error for the corresponding node. In response to the total number of errors for a layer exceeding a threshold, the NNT 102 updates the weights for the layer, then retrains the layer (that is, repeats application of the input data at the layer to generate output data for the next layer). The NNT 102 repeats this process for the layer until the number of errors at the layer is below the threshold, and then proceeds with training an error detection at the next layer. Thus, the NNT 102 detects errors at the level of individual layers, and also initiates retraining at the layer level in response to detecting a threshold number of errors. The NNT 102 thereby reduces both the length of individual training epochs, as well as the total number of epochs needed to train the neural network 110 as a whole.

In some embodiments, rather than retraining one or more layers in response to detecting a threshold number of errors, the processing system 100 instead signals an error to an executing application, so that the application is able to take remedial action to address or mitigate the detected error. For example, in some embodiments the neural network 110 is employed in an automated driving system and, in response to an indication of an error at the neural network 110, an executing application a driver to take back control of a semi-autonomous car, thereby mitigating the impact of the error.

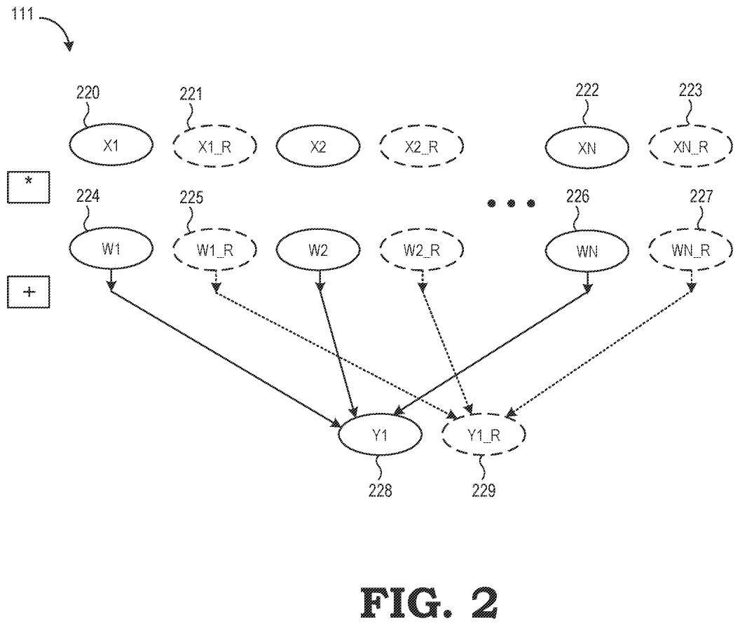

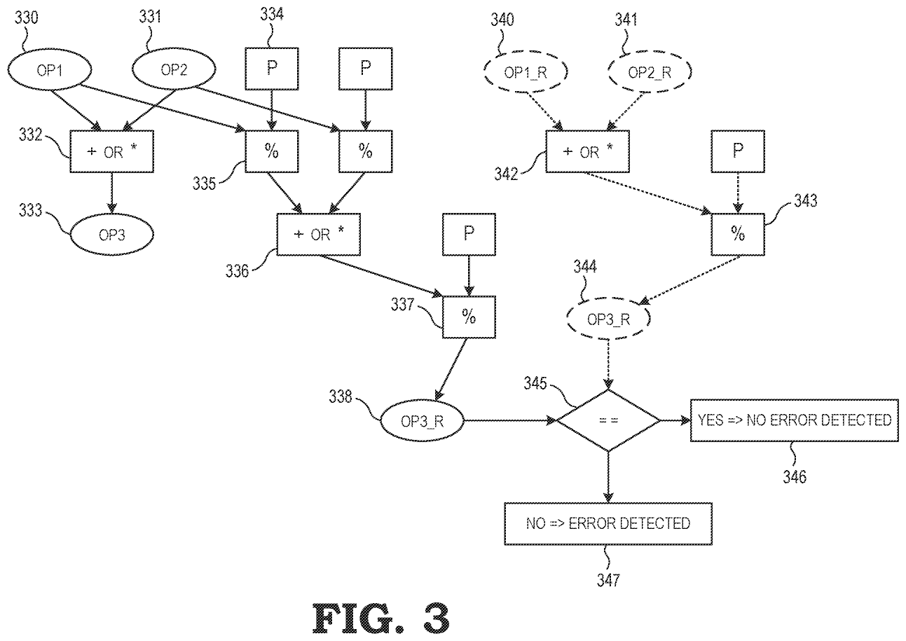

In some embodiments, the parallel nodes and data path determine the error values using a residue-based error detection mechanism. In these embodiments, the NNT 102 reads out operands and the corresponding residues from the analog resistive memory cells of the memory 104 for multiplication (*) and addition (+) operations, and then compares the corresponding operands and residues, post computation. Examples are illustrated and described with respect to FIGS. 2 and 3 in accordance with some embodiments.

FIG. 2 illustrates an example of a node of layer 111 including a primary data path and an error detection data path in accordance with some embodiments. In the depicted embodiment, the primary data path of the node calculates an output operand 228, designated Y1, based on a set of N input operands (e.g., input operands 220, 222) and a set of N weight operands (e.g., weight operands 224, 226). In particular, the value Y1 is generated according to the following equation:

$$Y 1 = {\sum }_{n = 1}^{N} X n * W n$$

where Xn is an input operand and Wn is the weight corresponding to the input operand.

The error detection data path loads calculates residual error values for each operand from the memory 104 and uses the loaded error values to calculate errors along the error detection data path. Thus, for example, residual error value 221 represents the residual error value for operand 220. The error detection data path therefore has N residual error values (e.g., residual error values 221, 223) corresponding to the N input operands, and N residual error values (e.g., residual error values 225, 227) corresponding to the N weights. The error detection data path calculates an output error value, designated Y1_R, according to the following equation:

$$Y1\_R = {\sum }_{n = 1}^{N} Xn\_R * Wn\_R$$

where Xn_R is the residual error value corresponding to Xn and Wn_R is the residual error value corresponding to Wn. The residue of an operand is computed as the modulo of the operand with respect to a specified prime number, designated p, and referred to herein as the residue factor. The modulo operation is designated with the sign “%”. Thus, the residue of an operand OP1 is given by the following equation:

OP1_{R}=OP1% p

The addition and multiplication operations involved in the computation are also performed modulo p, thereby allowing these operations to be performed quickly and consuming relatively little power while also allowing for robust error detection.

FIG. 3 illustrates an example of error detection at a node of the neural network 110 of FIG. 1 using residual values in accordance with some embodiments. In particular, FIG. 3 illustrates error detection associated with an individual arithmetic operation (addition or multiplication) at a node of the neural network 110 in accordance with some embodiments. In some embodiments, the error detection is performed for each arithmetic operation used to generate the output value of a given node of the neural network 110. In other embodiments, the error detection is performed for only a subset of the arithmetic operations, such as for the final calculation that generates the output operand.

To perform error detection, the error detector 105 uses the residual values for a set of operands to perform the same arithmetic operation, along the error data path, as is executed in the primary data path. The error detector 105 also generates residual values based on the arithmetic result generated at the primary data path. The error detector 105 compares the residual values generated by each of the primary data path and the error data path and, if the mismatch between the residual values exceeds a threshold, indicates an error for the node.

To illustrate with respect to FIG. 3, along the main data path the node performs an arithmetic operation (addition or multiplication), as indicated at block 332, using operands 330 and 331. The arithmetic operation generates a result operand 333. That is, the result operand 333 is the result operand along the primary data path.

In addition, the node generates residual values for the operands 330 and 331, as illustrated at block 335, and using a residue factor 334. At block 336, the node performs an arithmetic operation, corresponding to the arithmetic operation at block 332. That is, if the operation at block 332 is an addition operation, then the arithmetic operation at block 336 is also an addition operation and, similarly, if the operation at block 332 is a multiplication operation, then the arithmetic operation at block 336 is also a multiplication operation. At block 337, the node performs a modulo operation using the result generated at block 336 and using the residue factor 334. The node thus generates a residue value 338, corresponding to the residue of the output operand 333, based on the residue factor 334.

Concurrent with the above operations, the error data path for the node uses residue values 340 and 341 to perform the arithmetic operation for the node at block 342. The residue values 340 and 341 are residual values for the operands 330 and 331, respectively, calculated based on a modulo operation using the residue factor 334. In some embodiments, the residue values 340 and 341 are stored at the memory 104, in analog memory cells similar to those that store the operands 330 and 331. In other embodiments, the residue values 340 and 341 are stored in a different, more reliable memory, such as a single level cell non-volatile memory (NVM), thereby reducing the likelihood that the residue values 340 and 341 themselves have been erroneously stored. In other embodiments, the residue values 340 and 341 are stored at the analog memory cells of the memory 104 and are protected by error detection codes to reduce false positives (resulting from an erroneous residue but error-free operand) during error detection.

At block 343, the error data path performs a modulo operation on the result of the arithmetic operation executed at block 342 and using the residue factor 334. The result of this modulo operation is the residue value 344. If the operands 330 and 331 have been properly stored at the memory 104, it is expected that the residue value 338 matches the residue value 344, within a threshold tolerance. Accordingly, at block 345, the error detector 105 compares the residue value 338 with the residue value 344. In response to a mismatch between the residue values 338 and 344 that exceeds the threshold, the error detector 105 records an error for the node, as indicated at block 346. In response to the mismatch, if any, between the residue values 338 and 344 being within the threshold, the error detector 105 does not record an error for the node, as indicated at block 347.

In some embodiments, one or more of the factors or thresholds used by the processing system 100 to detect errors is different for different layers of the neural network 110. For example, in some embodiments, the residue factor 334 is different for at least two different levels of the neural network 110. In some embodiments, the threshold employed at block 345 to determine if there is a mismatch between the residue values 338 and 344 is different for at least two different levels of the neural network 110.

Further, in some embodiments, one or more of the factors or thresholds used by the processing system 100 to detect errors is a trainable value and is therefore adjusted during training of the neural network 110. For example, in some embodiments, the residue factor 334 is trainable, and is therefore adjusted for different training epochs of the neural network 110. In some embodiments, the threshold employed at block 345 to determine if there is a mismatch between the residue values 338 and 344 is trainable and is therefore adjusted for different training epochs of the neural network 110.

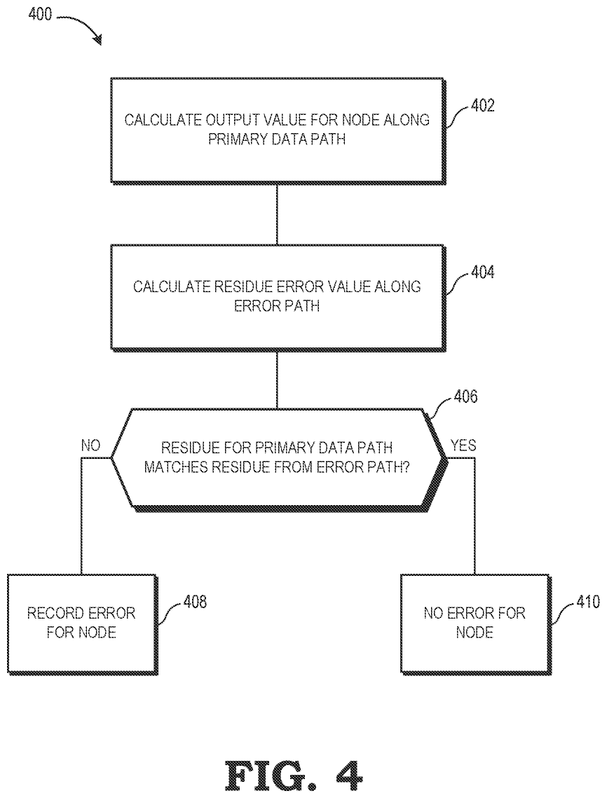

FIG. 4 is a flow diagram of a method 400 of detecting errors at a node of a neural network in accordance with some embodiments. For purposes of description, the method 400 is described with respect to an example implementation at the neural network 110 of FIG. 1 and using the primary data path and error data path described above with respect to FIG. 3. At block 402, the output value for the node is calculated along the primary data path for the node, using operands 330 and 331, and resulting in output operand 333. In addition, the residual value 338 is calculated along the primary data path, using residue values calculated based on the operands 330 and 331.

At block 404, the residue value 344 is calculated along the error data path, using residue values 340 and 341. At block 406, the error detector 105 compares the residue value 338 with the residue value 344 to determine if the difference between the residue values is less than a threshold tolerance. If not, the method flow proceeds to block 408 and the error detector 105 records an error for the node, as indicated at block 346. If, at block 406, the difference between the residue values exceeds the threshold, if any, between the residue values 338 and 344 being within the threshold, the error detector 105 does not record an error for the node.

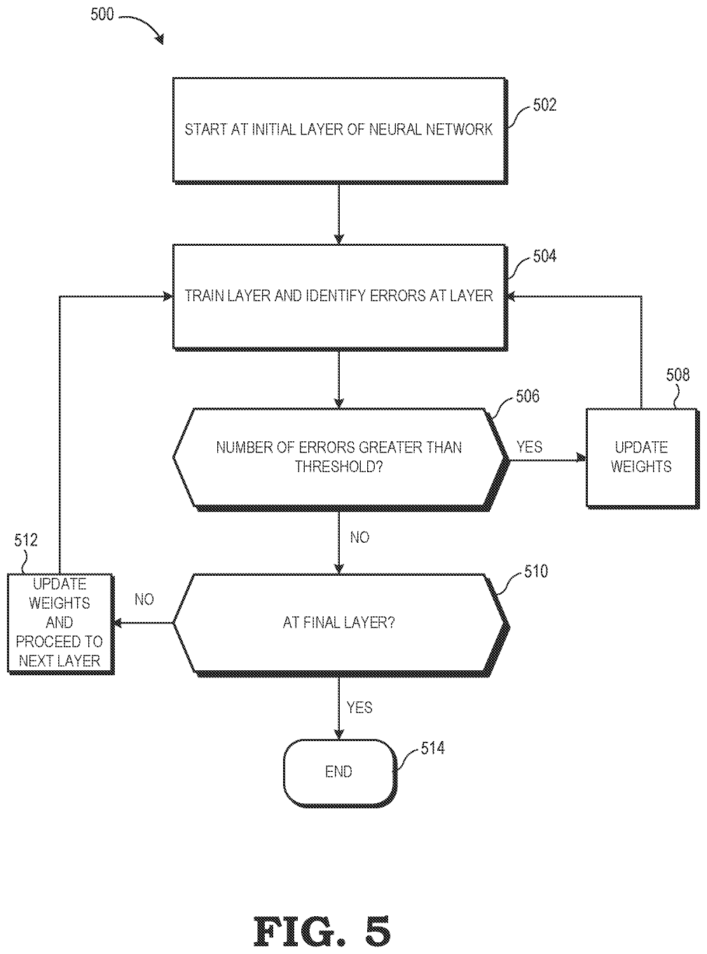

FIG. 5 is a flow diagram of a method 500 of retraining layers of a neural network based on detecting errors at the neural network layers in accordance with some embodiments. For purposes of description, the method 400 is described with respect to an example implementation at the neural network 110 of FIG. 1. At block 502, the NNT 102 initiates training at the neural network 110 by applying a set of specified training input values to an initial layer (e.g., layer 111) of the neural network 110. At block 504, the selected layer is trained by generating an output values for the layer nodes, based on the input values and weights for the respective nodes. In addition, at block 504, the error detector 105 identifies and records any errors at nodes of the layer, using the method 400 of FIG. 4 at each node.

At block 506, the error detector 105 determines whether the total number of errors detected at the selected layer exceeds a threshold value. In some embodiments, this threshold value is a trainable value that is adjusted for different training epochs of the neural network 110. If the total number of detected errors exceeds the threshold, the method flow proceeds to block 508 and the NNT 102 updates the weights for the layer. In other embodiments, the NNT 102 updates the weights for multiple layers of the neural network 110. The method flow then returns to block 504 and the selected layer is retrained. That is, the input values for the layer are again applied to the respective nodes, and each node generates an output value based on the respective input values and weights. In addition, error detection is again performed for the layer during the retraining.

Returning to block 506, once the number of detected errors for the selected layer is less than the threshold, the method flow moves to block 510 and the NNT determines if the selected layer is the final layer of the neural network 110. If not, the method flow moves to block 512 and the NNT 102 updates the weights for the selected layer, then selects the next layer of the neural network 110 (e.g., layer 112). The method flow then returns to block 504 and the newly selected layer is trained. If, at block 510, the NNT 102 determines that the selected layer is the final layer, the method flow moves to block 514 and the training epoch ends.

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
performing error detection for each layer of a plurality of layers of a neural network; and
retraining at least one layer of the neural network based on the detecting.

2. The method of claim 1, wherein the plurality of layers comprises a first layer including a plurality of nodes, and wherein detecting errors comprises:
performing error detection at each of the plurality of nodes.

3. The method of claim 2, wherein retraining comprises:
retraining the first layer in response to determining that a number of errors detected at the plurality of nodes exceeds a threshold.

4. The method of claim 3, wherein the threshold is a trainable value by the neural network.

5. The method of claim 2, wherein performing error detection comprises:
at each of the plurality of nodes, calculating a node operand value via a first path and calculating a redundant value at a second path operating in parallel to the first path.

6. The method of claim 2, wherein performing error detection comprises:
computing a residue value at each of the plurality of nodes.

7. The method of claim 6, wherein the residue value is based upon a trainable residue factor.

8. The method of claim 7, wherein a residue factor for the first layer is different than a residue factor for a second layer of the plurality of layers.

9. A method, comprising:
for a first layer of a plurality of layers of a neural network, detecting errors at nodes of the first layer; and
signaling an error based on a number of detected errors at the first layer.

10. The method of claim 9, further comprising:
for a second layer of the plurality of layers of a neural network, detecting errors at nodes of the second layer;
signaling the error based on a number of detected errors at the second layer.

11. The method of claim 9, wherein detecting errors at the first layer comprises:
generating, a node of the first layer, an operand via a first path;
generating, at the node of the first layer, an error value; and
detecting an error at the node of the first layer based on the operand and the error value.

12. The method of claim 11, wherein the error value comprises a residue of the operand.

13. An apparatus, comprising:
a memory configured to maintain:
a neural network;
an error detection circuit to perform error detection for each layer of a plurality of layers of the neural network; and
a processor comprising a training circuit to retrain at least one layer of the neural network based on the detecting.

14. The apparatus of claim 13, wherein the plurality of layers comprises a first layer including a plurality of nodes, and wherein the error detection circuit is to detect errors by:
performing error detection at each of the plurality of nodes.

15. The apparatus of claim 14, wherein the training circuit is to:
retrain the first layer in response to determining that a number of errors detected at the plurality of nodes exceeds a threshold.

16. The apparatus of claim 15, wherein the threshold is a trainable value by the neural network.

17. The apparatus of claim 14, wherein the error detection circuit is to perform error detection by:
at each of the plurality of nodes, calculating a node operand value via a first path and calculating an error value at a second path operating in parallel to the first path.

18. The apparatus of claim 14, wherein the error detection circuit is to perform error detection by:
computing a residue error value at each of the plurality of nodes.

19. The apparatus of claim 18, wherein the residue error value is based upon a trainable residue factor.

20. The apparatus of claim 19, wherein a residue factor for the first layer is different than a residue factor for a second layer of the plurality of layers.
